(19) United States
(12) Patent Application Publication
(10) Pub. No.: US 2023/0313920 A1
(43) Pub. Date: Oct. 5, 2023

(54) HOSE ATTACHMENT FITTING

(71) Applicant: Donald Stott, West Point, UT (US)

(72) Inventor: Donald Stott, West Point, UT (US)

(21) Appl. No.: 18/123,827

(22) Filed: Mar. 20, 2023

Related U.S. Application Data
(60) Provisional application No. 63/326,111, filed on Mar. 31, 2022.

(51) Int. Cl. F16L 19/10

(52) U.S. Cl. CPC F16L 19/10

(57) ABSTRACT

A hose attachment fitting may include a first, male fitting portion having a threaded portion and second, female fitting portion having threaded portion which engage one another to clamp a radiator hose to the inlet or outlet of a radiator, or to attach other hoses to structures, including engines, tanks and the like.

### BACKGROUND

### State of the Art

The present disclosure relates to hose attachment fittings which holds a hose, tubing or the like to another structure to provide a secure hold.

### Field of Art

There a wide variety of situations in which a hose or similar tube needs to be held securely to an inlet or outlet on a structure. One area in which hoses need to be held securely is in the context of engines. Numerous hoses pass various fluids between parts of the engine and a hose coming loose can have drastic consequences to the point of complete failure of the engine. While the present invention has a wide variety of uses, it will be discussed in the context of a radiator hose attachment for simplicity. It should be understood that the claims are not intended to limit the invention to this representative explanation.

A radiator is used to cool a cooling fluid which is used to cool the engine block of a vehicle. As shown in FIG. 1, a radiator 1 includes an outlet 2. The outlet 2 is connected to an engine block 3 by a lower radiator hose (shown in dashed lines). Cool coolant is passed from the radiator outlet 2 to the engine block 3 via the lower radiator hose. The coolant passes through the engine where it is warmed (thereby drawing heat out of the engine) and passes through the upper radiator house 4 (and inlet 5) and back into the radiator 1. The hot coolant fluid is passed through a radiator hose 4 and into an inlet 5 on the radiator 1. As the hot coolant passes through the radiator, the heat from the coolant is dissipated, typically by air passing over fins in the radiator. This causes the coolant to be cooler by the time it passes out of the radiator outlet 2 and back to the engine block 3.

The radiator inlet 5 and radiator outlet 2 are typically formed by a tube with a small annular projection or barb 7. The radiator hose 4 is slid over the annular projection and then is held in place with a clamp. This may be done with a band clamp 6 which is placed about the radiator hose 4 near the end thereof and between the annular projection 7 and the radiator 1. A screw on the band clamp 6 is tightened to cause the band clamp to clamp down on the hose and secure the hose between the band clamp and the inlet 5 or outlet 2.

While band clamps are easy to use, they do suffer from the problem that they do not respond well to repeated temperature changes. When the coolant is hot, it tends to expand the hose, thereby loosening the band clamp. To prevent this from happening, it is now common to use a spring hose clamp, also known as a constant tension clamp, wherein a piece of steel is wrapped into an overlapping circle with projections at each end to facilitate expanding the clamp by pulling the projections toward each other. When released, the spring hose clamp is able to adjust in size in response to expansion and contraction of the radiator hose.

One problem with band clamps and spring hose clamps is that they are not very aesthetically appealing. A small annular piece of steel resting on the hose often looks cheap and relatively insecure. Thus, there is a need for a more aesthetically pleasing clamp which securely holds the radiator hoses in place.

### SUMMARY

The following summary of the present disclosure is not intended to describe each illustrated embodiment or every possible implementation of the invention, but rather to give illustrative examples of application of principles of the invention.

In accordance with one aspect of the present disclosure, a hose attachment fitting which may comprise a hose clamp having first male fitting and a second female fitting which engage one another to clamp a radiator hose to a radiator inlet or outlet (or other hose to an inlet or outlet).

In accordance with one aspect of the disclosure, the male fitting may have male threading disposed thereon and one or more flat spots which facilitate holding the male fitting in a particular orientation while being mounted on a hose.

In accordance with one aspect of the disclosures, the male fitting may include a plurality of deflectable flanges disposed thereon.

In accordance with one aspect of the disclosure, the plurality of deflectable flanges may be more than two deflectable flanges.

In accordance with one aspect of the disclosure, the deflectable flanges may be disposed on a side of the male threading opposite the flat spots.

In accordance with one aspect of the disclosure, the hose clamp may include a second, female fitting, a portion of which has female threading.

In accordance with another aspect of the disclosure, the second, female fitting may have a plurality of flat spots on an outside of the fitting to facilitate engagement and holding of the second, female fitting.

In accordance with another aspect of the disclosure, the second, female fitting may include an inner collar. As the first, male fitting is rotated in a first direction the first, male fitting and the second, female fitting move toward one another, and the inner collar engages the plurality of flanges, thereby compressing the plurality of flanges inwardly to thereby secure a hose.

In accordance with another aspect of the disclosure, the threading on the first, male fitting and the threading on the second, female fitting are oriented so that the second, female fitting forms a locking nut on the first, male fitting.

In accordance with another aspect of the disclosure, the hose attachment fitting may be sized to accommodate hoses, tubes and the like of different sizes.

These and other aspects of the present disclosure may be realized in a hose attachment fitting which forms a hose clamp.

### BRIEF DESCRIPTION OF THE DRAWINGS

Various embodiments of the present disclosure are shown and described in reference to the numbered drawings wherein:

FIG. 1 shows a radiator hose attachment in accordance with principles of the prior art;

FIG. 2 shows a perspective view of a first, male fitting of a hose attachment fitting which forms part of a hose clamp;

FIG. 3 shows a cross-sectional view of the first, male fitting of claim 1 taken along the line A-A;

FIG. 4 shows a side view of the first, male fitting of FIG. 3 with sizes of one embodiment;

FIG. 5 shows a top view of the first, male fitting of FIG. 1 with measurements marked thereon;

FIG. 6 shows a perspective view of a second, female fitting of a hose clamp;

FIG. 7 shows a top view of the second, female fitting of FIG. 5;

FIG. 8 shows a side view of the second, female fitting;

FIG. 9 shows a cross-sectional view of the second, female fitting;

FIG. 10 shows a side view of the hose attachment fitting formed by the first, male fitting member and the second, female fitting member disposed on a radiator and radiator hose;

FIG. 11 shows an embodiment of a first, male fitting portion; and

FIG. 12 shows an embodiment of a second, female fitting portion.

It will be appreciated that the drawings are illustrative and not limiting of the scope of the invention, which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the apparatus and methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinary skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be more vertical than horizontal, i.e., would extend greater than 45 degrees from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

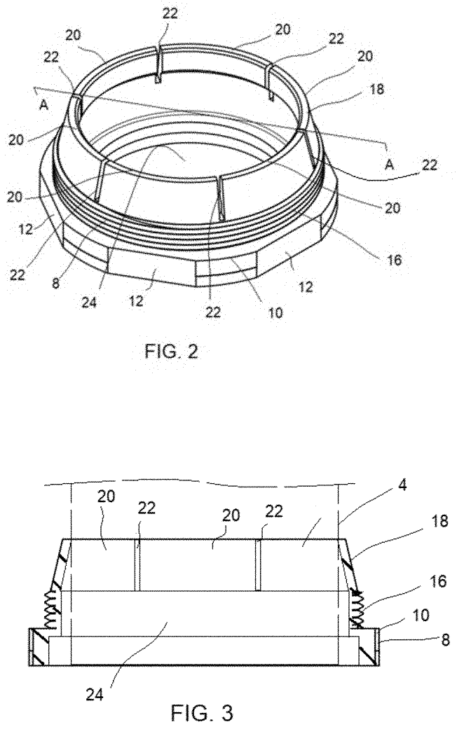

Turning now to FIG. 2, there is shown a perspective view of a first, male fitting portion 8. The first, male fitting portion 8 may include a collar portion 10 at one end. The collar portion 10 may be generally rounded and may have a plurality of flat faces 12 disposed about the collar portion to facilitate grabbing of the collar portion by a hand, wrench or some other gripping device. Disposed adjacent the collar portion 10 may be a threaded portion 16. In some embodiments the threads may be set at an angle to create a locking engagement when engaging the second, female fitting portion discussed below.

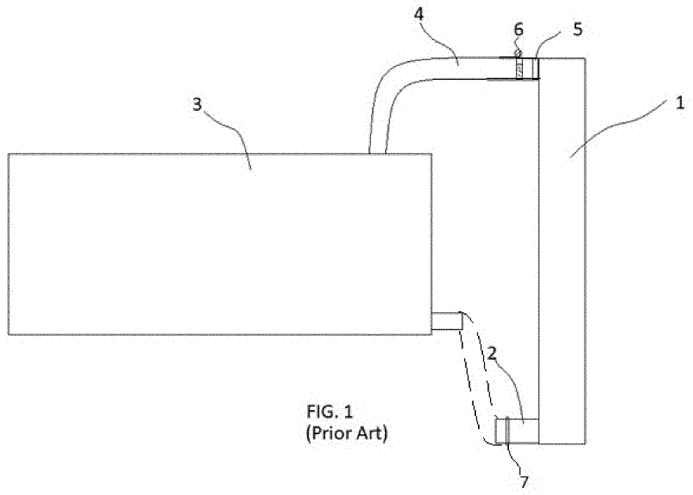

A deformable collar portion 18 may be disposed on a side of the threaded portion 16 opposite the collar portion. The deformable collar portion 18 may be formed by a generally annular collar which has a plurality of projections 20 which extend generally vertically to slightly inwardly at an angle of between about 70 and 85 degrees (when the first, male fitting portion 8 is resting on a horizontal surface on the end of the collar portion 10), and more preferably between about 76 to 77 degrees. The projections 20 may be formed by a plurality of channels 22 extending from a far end of the deformable collar portion 18 into the deformable collar portion and toward the threaded portion 16. The plurality of channels 22 may be, for example, between 0.325 to 0.350 inches long, with an ideal of about 0.335 inches, and between 0.040 and 0.080 inches wide, with a presently preferred width of about 0.060 inches. As shown in FIG. 1, the plurality of channels 22 extend substantially to one end of the threaded portion. As will be explained in additional detail below, the projections 20 can be deformed inwardly (i.e., toward the center of a void 24 extending through the first, male fitting portion 8) to engage a radiator hose disposed in the void and secure to the inlet or outlet of a radiator. (It will be appreciated that the hose fittings may also be used on a variety of other inlets or outlets to hold a hose or similar structure thereto.)

FIG. 3 shows a side cross-sectional view of the first, male fitting portion 8 taken along the line A-A in FIG. 2. A radiator hose 4 is depicted by dashed lines indicating how the radiator hose may fit into the void 24 in the first, male portion 8. The projections 20 of the deformable collar portion 18 are shown as extending inwardly, as they extend from the threaded portion 16. This inward slant may be present only on the outside surface of the projections, or on both surfaces as shown in FIG. 3. It will also be appreciated that the projections 20 may also extend completely vertically when in an ambient or resting portion.

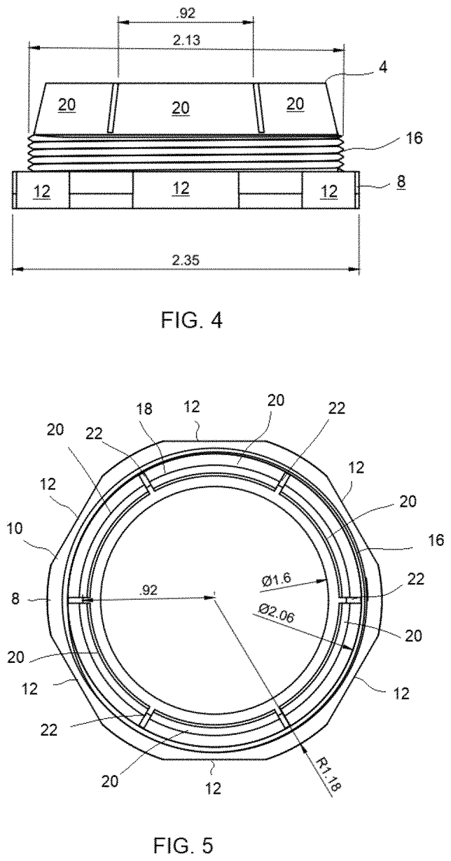

FIG. 4 shows a side view of the first, male fitting portion 8 and is marked in accordance with the discussion in FIGS. 2 and 3 above. There arrows with numbers written above them indicate one example of possible dimensions of various parts of the first, male fitting portion 8. For example, the collar portion 10 may be 2-3 inches wide, with 2.35 inches wide being preferred for this particular embodiment. The threaded portion threaded portion 16 may be between 2 and 2.5 inches wide, with 2.13 inches wide being preferred for this particular embodiment. The projections 20 of the deformable collar portion 18 may be, for example, 0.75 to 1.25 inches wide, with 0.92 inches wide being preferred for the embodiment shown. While these sizes work well for attachment of a radiator hose on certain vehicles, it will be appreciated that different sized inlets or hoses may dictate other dimensions and, in light of the present disclosure, a person of ordinary skill in the art could be able to determine appropriate dimensions based on the size of the hose and inlet/outlet. For example, if an inlet had a larger diameter and the user wished to use a thicker hose, the sizes discussed above would be increased for the most part. In contrast, a smaller outlet with a thinner hose could use a smaller mail fitting portion.

FIG. 5 shows a top view of the first, male fitting portion 8, with the inner radius being, as one example, 0.92 inches at the interior of the deformable collar portion 18 and the outer radius being 1.18 inches at the base of the projections. The innermost radius or curvature may be 1.6 inches, while the outside radius of curvature may be 2.06 inches at the threaded portion. FIG. 5 shows that there are six projections 20 evenly spaced about the male fitting portion 8. However, a smaller number such as 3 to 5 or a number greater than 6, e.g. 7 to 20, could be used depending on the size of the male fitting. It will be appreciated, however, that using two or three projections may make them harder to deflect as discussed below.

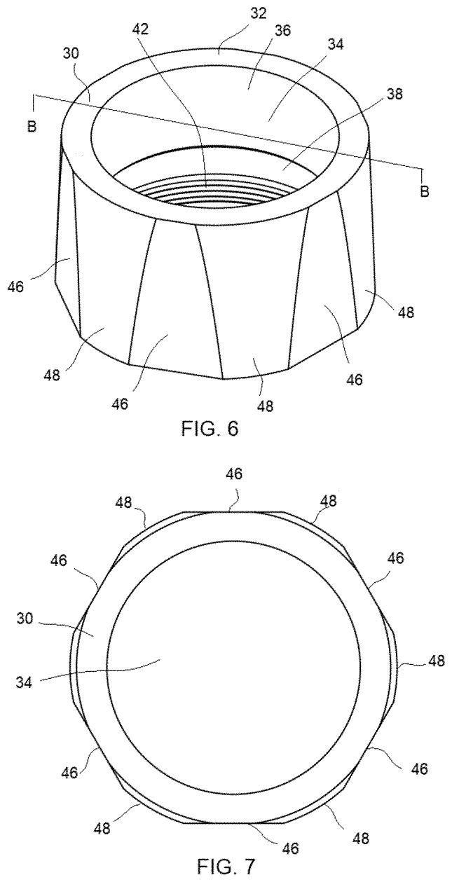

Turning now to FIG. 6, there is shown a perspective view of a second, female fitting portion 30. The second, female fitting portion 30 may be made from a generally annular or cylindrical piece of material, such as steel or a heavy-duty polymer or plastic so as to provide a generally annular wall 32 which defines a void 32 extending through the second, female fitting portion. The second, female fitting portion 30 may include a first upper wall portion 36, which may be substantially vertical or tapering inwardly at an angle of between about 0 and 10 degrees. A second wall portion 38 may be provided with an inward chamfer for engaging the projections 20 on the first, male fitting portion 8 (e.g., FIG. 3). The chamfer of about 70 and 85 degrees (when the first, male fitting portion 8 is resting on a horizontal surface on the end of the collar portion 10), and more preferably between about 74 to 76 degrees when resting in the position shown in FIG. 6. When engaging the projections 20 on the male fitting 8, the chamfer may apply a small amount of pressure on the projections, thereby causing the projections to deflect slightly and engage the hose to hold it secure.

It will be appreciated that the first upper wall portion and the second wall portion could be a single wall portion disposed at a desired angle. Adjacent thereto is a threaded portion 42 which may have female threads to engage with the threaded portion 16 of the first, male fitting portion 10. As the first, male fitting portion 10 or the second, female fitting portion 30 are rotated with respect to the other to tighten the threads, the first or second wall portions 36 or 38 may engage the projections 20 and push them inwardly, thereby securing them against the radiator hose 4 (FIG. 3).

The exterior of the second, female fitting portion 30 may include a plurality of generally flat or concave faces 46 which may be used to grip the second, female fitting portion 30 to rotate it, or to hold it still while the first, male fitting portion 10 is rotated to tighten or loosen the engagement between the two. The exterior of the second, female fitting portion 30 may also have a plurality of rounded faces 48. The faces may be generally rectangular, or may expand or contract in width as they extend from one end of the second, female fitting portion 30 to provide an aesthetically pleasing design.

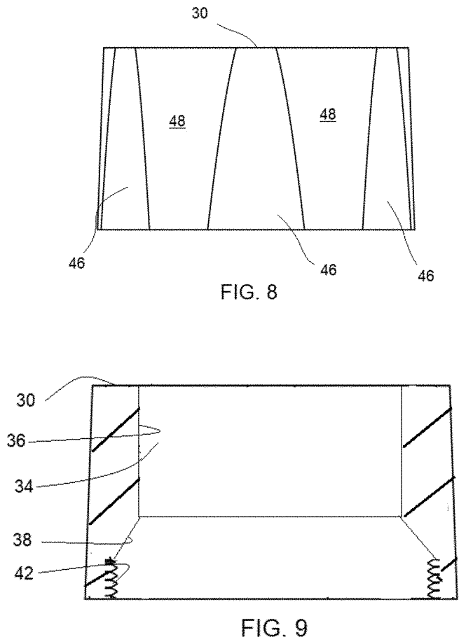

FIG. 7 shows a top view of the second, female fitting portion 30. The second, female fitting portion 30 is formed by a generally annular piece of material, such as a durable plastic, steel or other metal which defines a void 34 through which a hose or tube may pass. On an opposite side of the second, female fitting portion 30 may be a plurality of flat or concave faces 46 and a plurality of convex, rounded faces 48. FIG. 8 shows a side view numbered in accordance with the discussion above.

FIG. 9 shows a side cross-sectional view of a second, female fitting portion 30, defining a void 34, and having the first upper wall portion 36, the second wall portion 38, which is slanted or chamfered to push inwardly on the projections 20 (FIG. 3) as the first, male fitting portion 8 and second, female fitting portion 30 are tightened to one another.

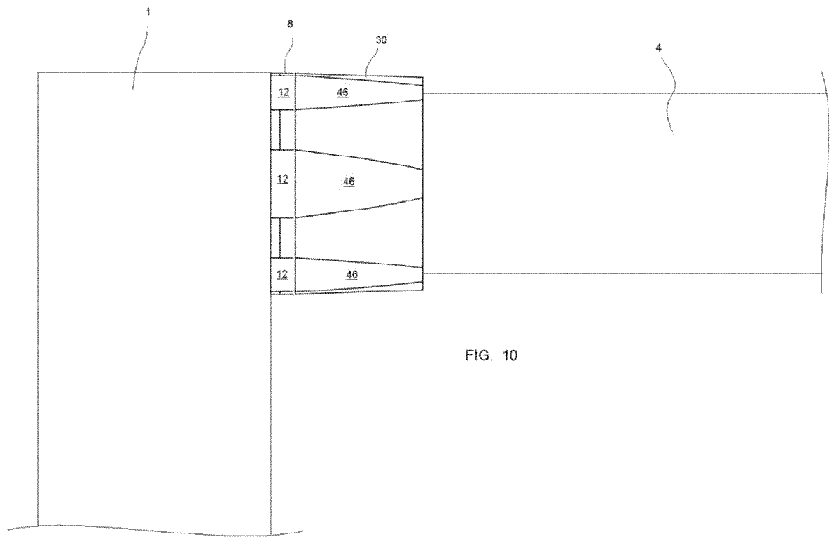

FIG. 10 shows a side view of the first, male fitting portion 8 and second, female fitting portion 30 tightened together on a hose 4, such as, for example, a radiator hose, to hold the hose to a structure, such as a radiator 1. The two fittings being tightened keeps the radiator hose 4 securely on the inlet or outlet of the radiator 1, while providing a much more aesthetic clamp for holding the radiator hose in place.

In use, the radiator hose 4 is selected and then the first, male fitting portion 8 and the second, female fitting portion 30 are mounted on the hose. If mounted on the end to be attached to the radiator, the second, female fitting portion 30 will usually be added on first and then the first, male fitting portion 8 will be added on to the hose.

The radiator hose 4 is then advanced onto the inlet or outlet of the radiator. If the inlet has a barb or an annular projection, the end of the hose and the first, male fitting portion 8 is disposed between the barb/annular projection and the radiator, etc., and the second, female fitting portion 30 is advanced and threaded onto the first, male fitting portion. As the second, female fitting portion 30 advances, the projections are deflected toward the radiator hose, thereby clamping the radiator hose between the inlet or outlet, and the hose attachment fitting. The second, female fitting portion 30 can be rotated until the radiator hose 4 is securely held and, if desired, so that the curved faces of the first, male fitting portion and the curved faces of the second, female fitting portion are disposed in alignment.

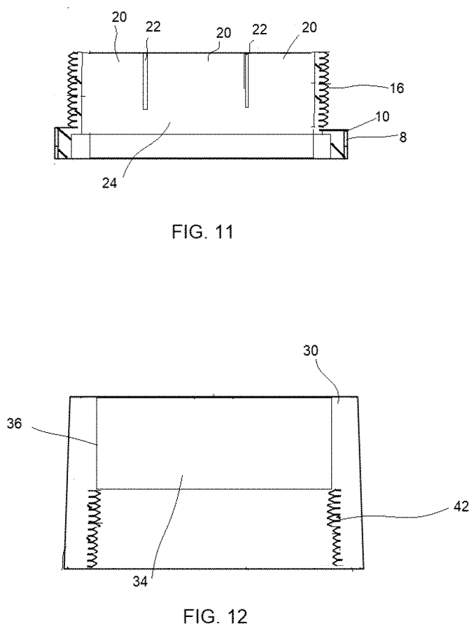

Turning now to FIGS. 11 and 12, there are shown cross-sectional views of an alternate embodiment of the hose attachment fitting. The first, male fitting portion 8 may include a collar portion 10 and a threaded portion 16. The projections 20 may be formed in the threaded portion 16 by forming the channels 22 therein. The second, female fitting portion 30 may have the upper wall portion 36 and threaded wall portion 42. The threaded wall portion 42 may slope inwardly as it extends from the bottom end, so that as the first, male fitting portion 8 and second, female fitting portion 30 are tightened, the projections are pushed inwardly—thus securing a radiator hose (not show) in the void 34 against the radiator inlet or outlet.

As mentioned previously, the hose attachment fitting could be used on other hoses on engines or other structures such as tanks, etc. that have hoses attached thereto. Common hoses on engines include the fuel hose, the power steering hose and the heater hose. Of course, different hoses may require hose attachment fittings which are of different sizes. Based on the previous discussion, hose attachment fittings of multiple difference sizes may be formed without undue experimentation.

It will be appreciated that various aspects of the present disclosure can be used in conjunction with other aspects of the disclosure and that various aspects may be omitted. For example, a hose fitting attachment hose attachment fitting may include a first, male fitting portion having a threaded portion and a plurality of deflectable projections and a second, female portion having a threaded portion. The first, male fitting portion may include a collar disposed adjacent the threaded portion and the deflectable projections may be disposed opposite the collar.

The collar may have a plurality of channels formed therein to form the plurality of deflectable productions, which may have an outer surface which is tapered inwardly as the deflectable projections extend away from the threaded portion. The deflectable projections may have an inner surface which is tapered inwardly as the deflectable projections extend away from the threaded portion. The collar portion may have a plurality of flat faces and a plurality of rounded faces.

The first, male fitting portion may have a void extending therethrough, and wherein the threaded portion is disposed on an opposite side of the first, male fitting portion as the void. The second, female fitting portion may have a first upper wall portion, a second wall portion which is angled outwardly as it extends downwardly from the first upper wall, and a threaded wall disposed adjacent the second wall portion. The second female fitting portion may include a plurality of flat faces and a plurality of rounded faces, which may taper from one end to the other.

The thread pitch on the threaded portion may typically be between 16 and 24. This allows pressure to provided to the projections and push them against the hose more gradual application of force. Other thread pitches may be used. Typically, sizes outside this range may be used, for example, for use with a hose which is 1 foot in diameter, a thread pitch of 14 may be used.

The present disclosure also discloses method for holding a hose to a fluid inlet or fluid outlet on a structure, which may include one or more of selecting a hose attachment fitting having a first, male fitting portion and a second, female fitting portion, disposing the second, female fitting portion on a hose, disposing the first, male fitting portion on the hose; advancing an end of the hose onto a fluid inlet or fluid outlet of the structure, positioning the first, male fitting portion adjacent the structure and advancing the second, female fitting portion onto the first, male fitting portion and rotating the second, female fitting portion and first, male fitting portion relative to one another until the hose is held firmly on the fluid inlet or fluid outlet of the structure.

The method may include using a first, male fitting portion which has a threaded portion and a plurality of projections and a second, female fitting portion has a threaded portion. The method may include engaging the threaded portion of the first, male fitting portion to the threaded portion of the second, female fitting portion and rotating the second, female fitting portion until the plurality of projections clamp the hose against the fluid inlet or fluid outlet of the structure.

The method may include using a second, female fitting portion includes a plurality of flat faces and engaging two of the faces with a wrench and rotating the second, female fitting portion. Likewise the method may include the first, male fitting portion having a plurality of curved faces, the second, female fitting portion has a plurality of curved faces and the method further including rotating the second, female fitting portion until the plurality of curved faces on the second, female fitting portion are disposed in alignment with the plurality of curved faces on the first, male fitting portion. The structure may include an engine and the method may include using the hose attachment fitting to hold the hose to the engine. The structure may be a radiator and the method may include using the hose attachment fitting to secure the hose to the radiator.

Thus, there is disclosed a hose attachment fitting. It will be appreciated that numerous modifications may be made without departing from the scope and spirit of this disclosure. The appended claims are intended to cover such modifications.

What is claimed is:

1. A hose attachment fitting comprising:
a first, male fitting portion having a threaded portion and a plurality of deflectable projections; and
a second, female portion having a threaded portion.

2. The hose attachment fitting of claim 1, wherein the first, male fitting portion has a collar portion disposed adjacent the threaded portion.

3. The hose attachment fitting of claim 2, wherein the first, male fitting has a deflectable generally annular collar disposed on a side of the threaded portion opposite the collar portion.

4. The hose attachment fitting of claim 3, wherein the deflectable generally annular collar has a plurality of channels formed therein to form the plurality of deflectable projections.

5. The hose attachment fitting of claim 4, wherein the deflectable projections have an outer surface which is tapered inwardly as the deflectable projections extend away from the threaded portion.

6. The hose attachment fitting of claim 4, wherein the deflectable projections have an inner surface which is tapered inwardly as the deflectable projections extend away from the threaded portion.

7. The hose attachment fitting of claim 2, wherein the collar portion has a plurality of flat faces and a plurality of rounded faces.

8. The hose attachment fitting of claim 7, wherein the first, male fitting portion has a void extending therethrough, and wherein the threaded portion is disposed on an opposite side of the first, male fitting portion as the void.

9. The hose attachment fitting of claim 1, wherein the second, female fitting portion comprises a first upper wall portion, a second wall portion which is angled outwardly as it extends downwardly from the first upper wall, and a threaded wall disposed adjacent the second wall portion.

10. The hose attachment fitting of claim 9 wherein the second, female fitting portion includes a plurality of flat faces and a plurality of rounded faces.

11. The hose attachment fitting of claim 10, wherein the plurality of flat faces taper from one end to the other.

12. A method for holding a hose to a fluid inlet or fluid outlet on a structure, the method comprising:
selecting a hose attachment fitting having a first, male fitting portion and a second, female fitting portion;
disposing the second, female fitting portion on a hose;
disposing the first, male fitting portion on the hose;
advancing an end of the hose onto a fluid inlet or fluid outlet of the structure;
positioning the first, male fitting portion adjacent the structure; and
advancing the second, female fitting portion onto the first, male fitting portion and rotating the second, female fitting portion and first, male fitting portion relative to one another until the hose is held firmly on the fluid inlet or fluid outlet of the structure.

13. The method according to claim 12, wherein the first, male fitting portion has a threaded portion and a plurality of projections and wherein the second, female fitting portion has a threaded portion and wherein the method comprises engaging the threaded portion of the first, male fitting portion to the threaded portion of the second, female fitting portion and rotating the second, female fitting portion until the plurality of projections clamp the hose against the fluid inlet or fluid outlet of the structure.

14. The method according to claim 12, wherein the second, female fitting portion includes a plurality of flat faces and wherein the method comprises engaging two of the faces with a wrench and rotating the second, female fitting portion.

15. The method according to claim 12, wherein the first, male fitting portion has a plurality of curved faces and wherein the second, female fitting portion has a plurality of curved faces and wherein the method comprises rotating the second, female fitting portion until the plurality of curved faces on the second, female fitting portion are disposed in alignment with the plurality of curved faces on the first, male fitting portion.

16. The method according to claim 12, wherein the structure is an engine, and the method comprises using the hose attachment fitting to hold the hose to the engine.

17. The method according to claim 12, wherein the structure is a radiator and wherein the method comprises using the hose attachment fitting to secure the hose to the radiator.

18. A hose attachment fitting comprising:
a first, male fitting portion having a collar portion, a threaded portion and a plurality of deflectable projections. and
a second, female portion having a threaded portion.

19. The hose attachment fitting of claim 18, wherein the second female portion including a threaded portion and an angled wall portion disposed so that rotating the second, female portion relative to the first, male portion draws the first, male portion and the second female portion toward each other and deflects the plurality of deflectable projections.

20. The hose attachment fitting of claim 19, wherein the plurality of deflectable projections are disposed around a void passing through the first, male portion, the plurality of deflectable projections being separated by a plurality of channels running generally parallel to the void.
